(19) United States
(12) Patent Application Publication
(10) Pub. No.: US 2012/0255406 A1
(43) Pub. Date: Oct. 11, 2012

(54) Method and Apparatus for Pipe-End Shaving

(75) Inventor: Donald T. Mainolfi, Oxford, CT (US)

(73) Assignee: SPEED BEVELER, LLC, Monroe, CT (US)

(21) Appl. No.: 13/440,476

(22) Filed: Apr. 5, 2012

Related U.S. Application Data
(60) Provisional application No. 61/516,632, filed on Apr. 5, 2011.
(60) Provisional application No. 61/518,199, filed on May 2, 2011.

(51) Int. Cl. B23B 5/16; B23B 27/00; B23B 1/00

(52) U.S. Cl. 82/1.11; 408/203.5

(57) ABSTRACT

A pipe-shaving apparatus has a cylindrical section, a base section and a drive shaft connected to the base section for rotation. The cylindrical section has a cylindrical wall dimensioned to fit the outer diameter of a pipe. The cylindrical wall has a plurality of windows and a plurality of angle-cutting edges. Each angle-cutting edge is located at the trailing side of the window. When the cylindrical wall is caused to rotate and the pipe is inserted into the inner space of the cylindrical wall, the angle-cutting edges shave off the outer diameter of the pipe-end section. The base section has one or more openings and one or more front-cutting edges located on the trailing side of the openings. When the pipe-end section is further inserted into the inner space of the cylindrical section, the front-cutting edges shave off the front part of the pipe-end section.

### CROSS REFERENCE

This application is based on and claims priority to U.S. Provisional Application Ser. No. 61/516,632, filed Apr. 5, 2011, and U.S. Provisional Application Ser. No. 61/518,199, filed May 2, 2011.

### FIELD OF THE INVENTION

The present invention relates generally to a pipe beveling apparatus and, more particularly, to a portable pipe beveler which can be engaged with a power tool for rotation.

### BACKGROUND OF THE INVENTION

When a pipe is connected to another pipe, one pipe may have a hub known as a bell end and the other pipe may have a spigot end with an outer diameter dimensioned to fit the inner diameter of the bell end. As such, the spigot can be inserted into the bell end to form a joint, as shown in FIG. 1. It is common practice to taper the bell end such that the inner diameter of the bell end is gradually reduced so as to serve as a stop to the inserted spigot. It is also common practice to bevel the end of the spigot so that the beveled end of the spigot is at least partly engaged with the reduced inner diameter of the bell.

### SUMMARY OF THE INVENTION

The present invention provides a pipe shaving apparatus for shaving off part of an end section of a pipe. The shaving apparatus has a cylindrical section and a base section connected to the cylindrical section. The cylindrical section has a cylindrical wall dimensioned to fit the outer diameter of the pipe. The cylindrical wall has a plurality of windows and a plurality of angle-cutting edges. Each of the angle-cutting edges is located at one side of the window and is bent out of the cylindrical wall, partly intruding into the inner space of the cylindrical section. As such, when the cylindrical wall is caused to rotate and the pipe is inserted into the inner space of the cylindrical wall, the angle-cutting edges shave off the outer diameter of the pipe-end section. Furthermore, the base section comprises a base plate having one or more openings and one or more front-cutting edges. The front-cutting edge is located on one side of an opening, partly bent out of the base plate toward the inner space of the cylindrical section. As such, when the pipe-end section is further inserted into the inner space of the cylindrical section, the front-cutting edges shave off the front part of the pipe-end section.

Thus, the first aspect of the present invention is a pipe shaving apparatus, which comprises: a cylindrical section, a base section connected to the cylindrical section, and a drive shaft securely attached to the base section. The cylindrical section comprises a cylindrical wall having a plurality of windows and a plurality of angle-cutting edges, each edge located at one side of a window. The angle-cutting edge is bent out of the cylindrical wall, partly intruding into the inner space of the cylindrical section. The base section comprises a base plate having one or more openings and one or more front-cutting edges. The front-cutting edge is located on one side of an opening, partly bent out of the base plate toward the inner space of the cylindrical section. Furthermore, the pipe shaving apparatus also has a drive shaft securely fastened to the base plate. The drive shaft is dimensioned to be engaged with a power tool for rotation.

Furthermore, the pipe shaving apparatus also has a drive shaft securely fastened to the base plate. The drive shaft is dimensioned to be engaged with a power tool for rotation.

The second aspect of the present invention is a method for shaving a pipe-end section, the pipe-end section having an outer diameter and an end surface. The method comprises providing a cylindrical wall and a base plate connected to the cylindrical wall, wherein the cylindrical wall comprises a plurality of windows and the base plate comprises one or more opening, and wherein the cylindrical wall has an inner diameter dimensioned to fit the outer diameter of the pipe-end section; providing a plurality of angle-cutting edges on the cylindrical wall, each angle-cutting edge located on one side of a window; providing one or more front-cutting edges on the base plate, each front-cutting edge located on one side of an opening; causing the cylindrical wall to rotate relative to the pipe-end section and engaging the cylindrical wall with the pipe-end section such that the pipe-end section is at least inserted into part of the inner space of the cylindrical wall so as to allow one or more angle-cutting edges to shave off part of the outer diameter of the pipe-end section and to allow one or more of the front-cutting edges to shave off part of the end surface of the pipe-end section.

### BRIEF DESCRIPTION OF THE DRAWINGS

FIG. 1 shows a joint in which a spigot is fitted into a bell.

FIG. 2 shows an end of a cylindrical pipe.

FIG. 2a shows a cross sectional view of a pipe end before beveling.

FIGS. 3a and 3b show two perspective views of the pipe shaving tool, according to one embodiment of the present invention.

FIG. 4 shows a front-view of the pipe-shaving tool, according to one embodiment of the present invention.

FIG. 4a shows a detailed view of the front-cutting edge.

FIG. 5 shows a cross sectional view of the pipe-shaving tool of FIG. 4.

FIG. 5a shows a detailed view of the angle-cutting edge.

FIG. 6 is another detailed view of the front-cutting edge.

FIGS. 7 and 7a show a beveled cylindrical pipe.

FIG. 8 shows a replaceable angle-cutting edge.

FIG. 9 shows another embodiment of the present invention.

### DETAILED DESCRIPTION OF THE INVENTION

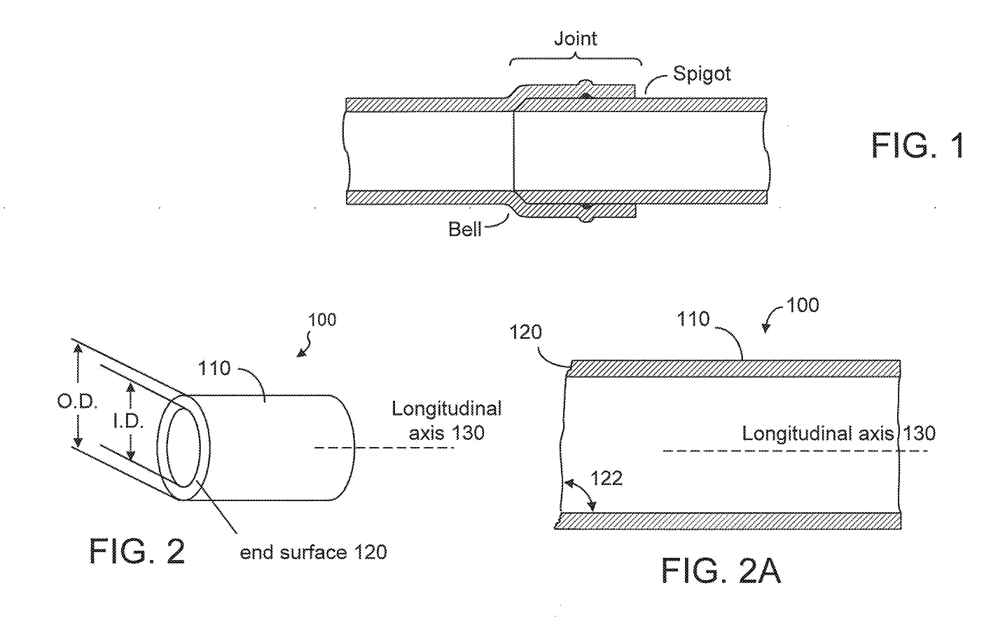

The present invention provides a tool or apparatus for shaving off part of an end section of a pipe. As shown in FIG. 2, the pipe-end section 100 has a cylindrical wall bounded by an outer diameter (O.D.) and an inner diameter (I.D.) and the pipe-end section has an end surface 120 of the wall. The cylindrical wall of the pipe-end section (hereafter referred to as pipe wall) has an outer wall surface 110 and a longitudinal axis 130. Depending upon how the pipe is cut, it is possible that the end surface 120 is not perpendicular to the longitudinal axis 130 and the end surface 120 is not smooth or even. When the end surface 120 is not perpendicular to the longitudinal axis 130, the end surface is at an acute angle 122 relative to the longitudinal axis of the pipe, as seen in FIG. 2a. This is understood that such an end surface, even if beveled, would not form a tight joint when mated to the bell end of another section of pipe shown in FIG. 1.

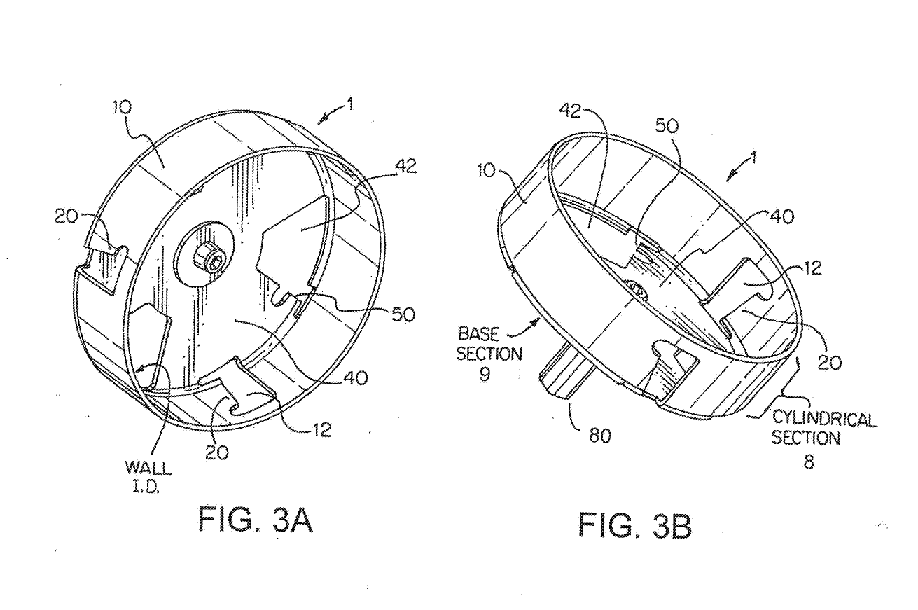

The pipe shaving tool 1, according to the present invention, has a cylindrical section 8 connected to a base section 9. The shaving tool 1 is sometimes referred to as a pipe beveler. The cylindrical section 8 has a cylindrical wall 10 having an inner diameter dimensioned to fit the outer diameter of the pipe wall. The cylindrical wall 10 has a plurality of windows 12 and a plurality of angle-cutting edges 20. The base section has a base plate 40 with one or more openings 42 and one or more front-cutting edges 50. According to one embodiment of the present invention, each angle-cutting edge 20 is located on one side of a window 12, facing the window 12. Each of the openings 42 has a front-cutting edge 50 associated thereto, as shown in FIGS. 3a and 3b. As shown in FIG. 3b, the shaving tool 1 comprises a drive shaft 80 securely attached to the base plate 40. The drive shaft 80 is configured to be engaged in a spindle of a drill or other power tool for rotation, for example. As such, the shaving tool 1 can be caused to rotate or spin in a spinning direction relative to a substantially stationary pipe-end section. When spinning occurs, each of the windows 12 on the cylindrical wall 10 has a leading side and a trailing side, and the angle-cutting edge 20 is located at the trailing side of the window 12. Likewise, each of the openings 42 on the base plate 40 has a leading side and a trailing side, and the front-cutting edge 50 is located on the trailing side. For example, the shaving tool 1 as shown in FIG. 3A is configured to rotate or spin in a counter-clockwise direction.

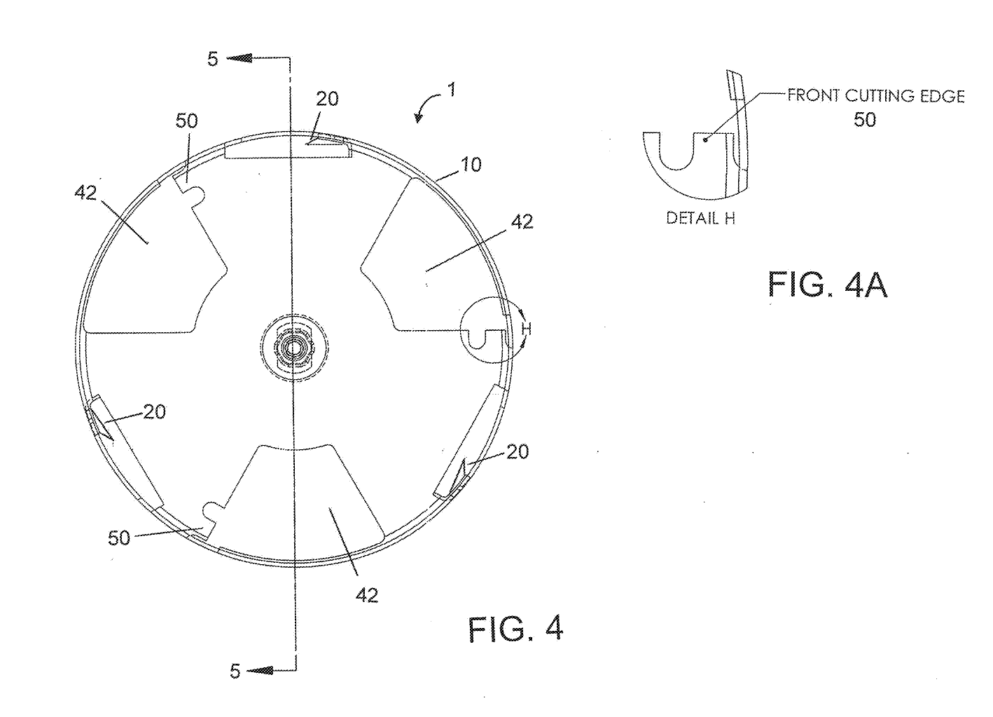

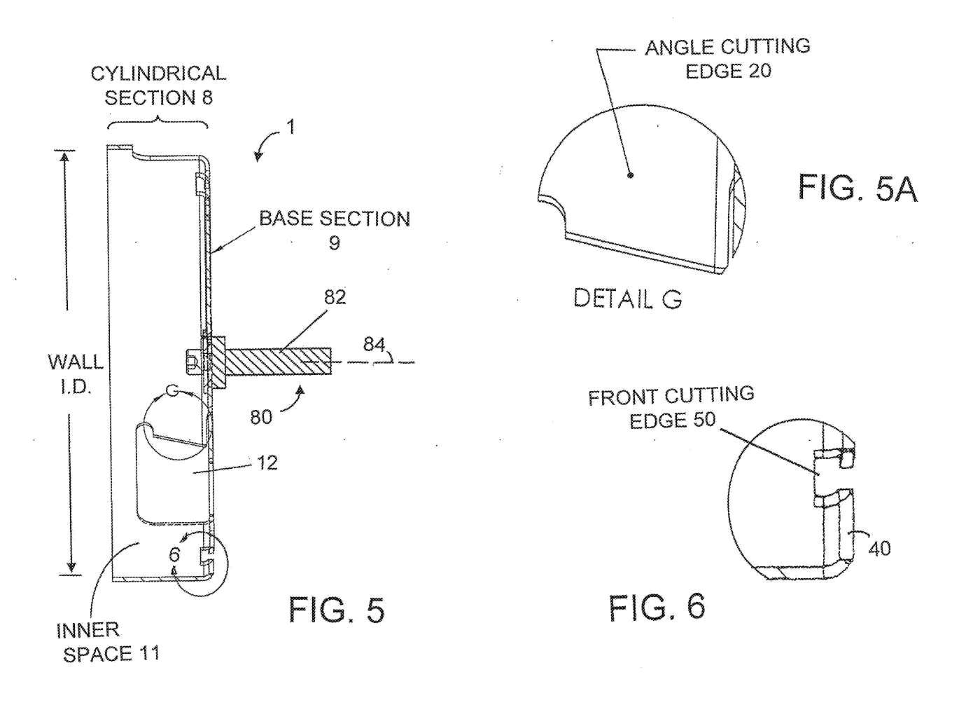

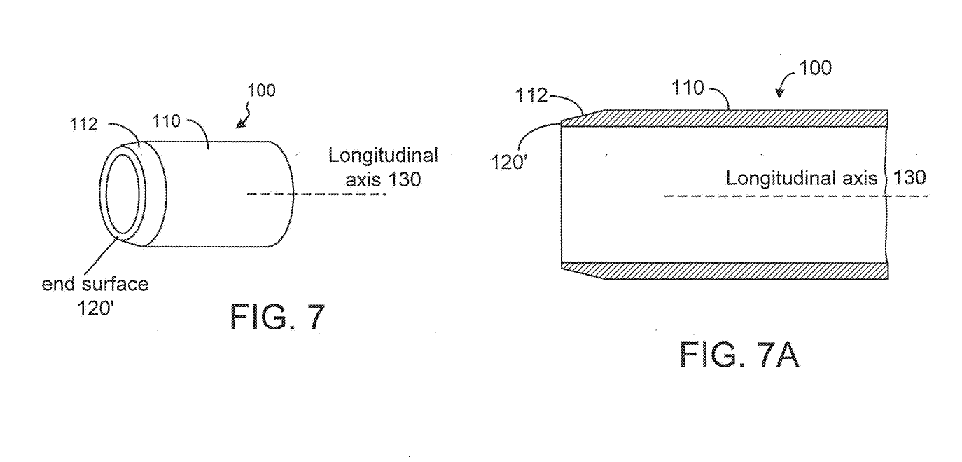

FIG. 4 shows the front-view of the shaving tool 1, according to one embodiment of the present invention. As shown in FIG. 4, the base plate 40 has three openings 42 and each of the openings 42 has a front-cutting edge 50 located on one side of the opening 42. A detailed view of a front-cutting edge 50 is shown in FIG. 4a. The cylindrical wall 10 has the inner diameter (WALL I.D.). The base section and the inner diameter of the cylindrical wall define the inner space 11 of the cylindrical section as shown in FIG. 5. As shown in FIG. 5, the drive shaft 80 has a shaft body 82 having a shaft axis 84 to define the rotation axis of the cylindrical section for spinning. Each of the angle-cutting edges 20 is partly intruding into the inner space of the cylindrical section as shown in FIG. 4. A detailed view of the angle-cutting edge 20 is shown in FIG. 5a. Furthermore, as shown in FIGS. 5 and 6, each of the front-cutting edges is bent out of the surface of the base plate 40, toward the inner space of the cylindrical section 8. As such, when the drive shaft 80 is engaged with a power tool for rotation, the entire shaving tool 1 spins in a spinning direction. When the spinning shaving tool is engaged with a pipe-end section 100, the angle-cutting edges 20 are dimensioned to shave off the outer wall surface 110 of the pipe in order to make a beveled edge 112 on the pipe-end section, as shown in FIG. 7. A detailed view of a front-cutting edge 50 is shown in FIG. 6a. When the edge of the pipe-end section is in contact with one or more of the front-cutting edges 50, the spinning front-cutting edges 50 also shave off at least part of the end surface 120 of the pipe. The front-cutting edges 50 are configured to smooth out the end surface 120 of the pipe-end section and to make the end surface substantially perpendicular to the longitudinal axis 130 of the pipe-end section.

The resulting pipe at its pipe-end section is illustrated in FIGS. 7 and 7A. As shown in FIGS. 7 and 7A, the pipe-end section 100 has an end surface 120′ and a tapered outer wall surface 112 extended from the outer wall surface 110. The end surface 120′ is substantially perpendicular to the longitudinal axis 130 of the pipe-end section 100, even when the end surface 120 of the pipe-end section (see FIG. 2) has an angled end (not substantially perpendicular to the longitudinal axis 130 of the pipe-end section) prior to operations of the shaving tool 1.

In the embodiment as shown in FIGS. 3a, 3b and 4, there are three openings 42 on the base plate 40 and three windows 12 on the wall 10 of the cylindrical section. With these windows and openings, it is easier to see how the pipe-end section is engaged inside the inner section of the wall 10. The windows and the openings also allow the shavings to move away from the shaving tool. It is understood that the number of windows and openings can be smaller or greater than three. For example, the number of windows can be two or four. Likewise, the number of openings can also be one, two, four or more.

The shaving tool 1 of the present invention, can be made of steel such as CRS 1008 and CRS 1050, but it can be made of any suitable material. The thickness of the wall can be about 0.06 inch (1.52 mm), but it can also be thinner or thicker. For example, on a pipe shaving tool to be used on a 6-inch pipe, the outer diameter of the cylindrical wall is 6.42 inches and the inner diameter is 6.30 inches. On a pipe shaving tool to be used on an 8-inch pipe, the outer diameter of the cylindrical wall is 8.55 inches and the inner diameter is 8.43 inches. The length of the cylindrical section can be 1.5 inches (38.1 mm), but it can be longer or shorter. On a pipe shaving tool to be used on a 4-inch pipe, the outer diameter of the cylindrical wall is 4.36 inches and the inner diameter is 4.25 inches. The length of the cylindrical section can be 1.25 inches (31.75 mm), but it can be longer or shorter.

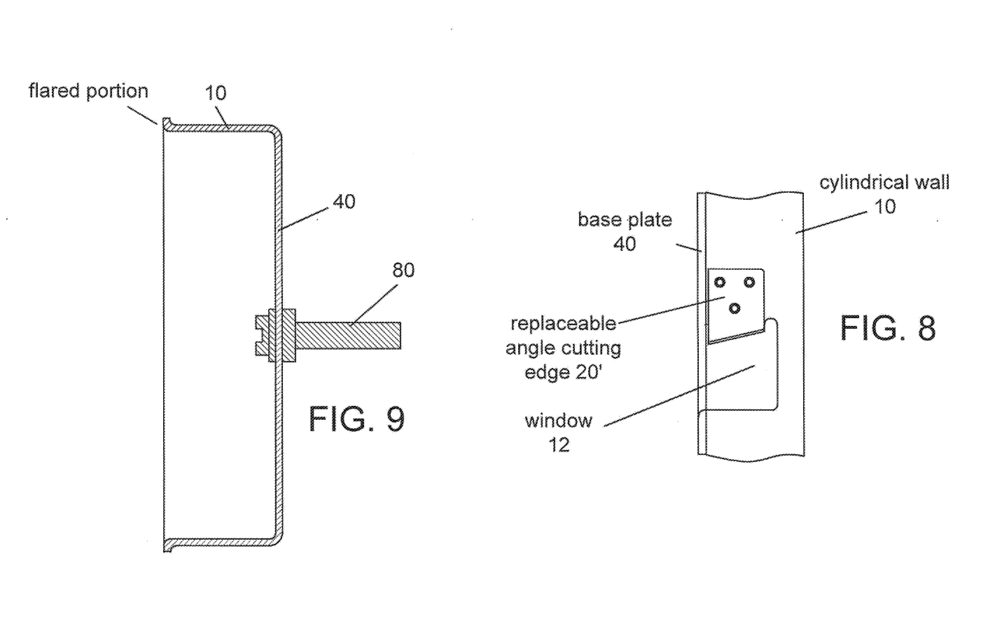

It should be understood by a person skilled in the art that, the physical dimensions as given above are only examples. When the tool is intended to be used on a larger pipe, the length and the thickness of the cylindrical wall could be greater. When the tool is intended to be used on a smaller pipe, the length and the thickness of the cylindrical wall could be reduced. Furthermore, in one embodiment of the present invention, the angle-cutting edges 20′ are replaceable, as shown in FIG. 8.

According to another embodiment of the present invention, the cylindrical wall has a flared end. As shown in FIG. 9, one end of the cylindrical wall 10 is connected to the base plate 40 and the other end of the cylindrical wall 10 has a flared portion. The flared portion is used to minimize the distortion of the shape of the cylindrical wall, during manufacturing, including heat treating or operation of the shaving tool.

In summary, the pipe shaving apparatus according to the present invention comprises a cylindrical section, a base section connected to the cylindrical section, and a drive shaft securely attached to the base section. The cylindrical section comprises a cylindrical wall having a plurality of windows and a plurality of angle-cutting edges, each edge located at one side of a window. The angle-cutting edge is bent out of the cylindrical wall, partly intruding into the inner space of the cylindrical section. The base section comprises a base plate having one or more openings and one or more front-cutting edges. The front-cutting edge is located on one side of an opening, partly bent out of the base plate toward the inner space of the cylindrical section. Furthermore, the pipe shaving apparatus also has a drive shaft securely fastened to the base plate. The drive shaft is dimensioned to be engaged with a power tool for rotation.

The shaving tool (also known as a pipe beveler), according to the present invention, is used for two purposes. It is used to bevel the end of a pipe using a plurality of angle-cutting edges. It is also used to reface the end of the pipe using a plurality of front-cutting edges. After the pipe end is shaved with the shaving tool of the present invention, the resulting pipe has a tapered outer wall at its end. Furthermore, the end surface of the pipe is perpendicular to the longitudinal axis of the pipe. The shaving tool may have a flared portion at the open end of the cylindrical section.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. An apparatus, comprising:
a cylindrical section;
a base section connected to the cylindrical section; and
a drive shaft securely attached to the base section, the cylindrical section comprising a cylindrical wall having a plurality of windows and a plurality of angle-cutting edges, each angle-cutting edge located at one side of a window.

2. The apparatus according to claim 1, wherein the cylindrical wall comprises a first end and an opposing section end, and the base section comprises a base plate securely connected to the second end of the cylindrical wall, the cylindrical wall comprising an inner diameter, the cylindrical section comprising an inner space defined by the inner diameter of the cylindrical wall and the base section, and wherein each of the angle-cutting edges is bent out of the cylindrical wall, partly intruding into the inner space of the cylindrical section.

3. The apparatus according to claim 2, wherein the base plate comprises one or more openings and one or more front-cutting edges, each of said one or more front-cutting edges located on one side of an opening, partly bent out of the base plate toward the inner space of the cylindrical section.

4. The apparatus according to claim 3, wherein the base plate comprises a first side and an opposing second side, the first side facing the inner space of the cylindrical section, and wherein the drive shaft is securely attached to the base plate, the drive shaft comprising a shaft body extending outward from the second side of the base plate, the shaft body having a shaft axis defining a rotational axis of the cylindrical section, the shaft body dimensioned to engage with a tool for rotation.

5. The apparatus according to claim 4, wherein when the shaft body is engaged with a tool for rotation in a rotating direction, each of the windows comprises a leading side and a trailing side, and wherein each of the angle-cutting edges is located on the trailing side of a window.

6. The apparatus according to claim 4, wherein when the shaft body is engaged with a tool for rotation in a rotating direction, each of said one or more openings comprises a leading side and a trailing side, and wherein each front-cutting edge is located on the trailing side of an opening.

7. The apparatus according to claim 1, wherein each of the angle-cutting edges is part of the cylindrical wall.

8. The apparatus according to claim 1, wherein each of the angle-cutting edges is securely attached to the cylindrical wall.

9. The apparatus according to claim 3, wherein each of the front-cutting edge is part of the base plate.

10. The apparatus according to claim 2, wherein the first end of the cylindrical wall comprises a flared portion having an enlarged inner diameter greater than the inner diameter of the cylindrical wall.

11. A method for shaving a pipe-end section, the pipe-end section having an outer diameter and an end surface, the method comprising:
providing a cylindrical section, and a base section connected to the cylindrical section, the cylindrical section comprising a cylindrical wall having an inner diameter dimensioned to fit the outer diameter of the pipe-end section, wherein the base section and the inner diameter of the cylindrical wall define an inner space of the cylindrical section;
providing a plurality of windows on the cylindrical wall;
providing a plurality of angle-cutting edges on the cylindrical wall, each of the angle-cutting edges located on one side of a window; and
causing the cylindrical wall to rotate relative to the pipe-end section and engaging the cylindrical wall with the pipe-end section such that the pipe-end section is at least inserted into part of the inner space of the cylindrical wall so as to allow one or more angle-cutting edges to shave off part of the outer diameter of the pipe end section.

12. The method according to claim 11, wherein the cylindrical wall comprises a first end and an opposing second end, and the base section comprises a base plate securely connected to the second end of the cylindrical wall, said method further comprising:
providing one or more openings on the base plate;
providing one or more front-cutting edges on the base plate, each front-cutting edge located on one side of an opening, partly bent out of the base plate toward the inner space of the cylindrical section; and
further engaging the cylindrical wall with the pipe-end section to allow one or more of the front-cutting edges to shave off part of the end surface of the pipe-end section.

13. The method according to claim 11, wherein each of the angle-cutting edges is part of the cylindrical wall and bent out of the cylindrical wall toward the inner space of the cylindrical section.

14. The method according to claim 11, wherein each of the angle-cutting edges is securely attached to the cylindrical wall, at least partly intruding into the inner spacer of the cylindrical section.

15. The method according to claim 11, further comprising:
securely attaching a drive shaft to the base plate, the drive shaft dimensioned for engagement with a power tool for causing the cylindrical wall to rotate.

16. The method according to claim 12, further comprising:
enlarging the first end of the cylindrical wall for providing a flared portion of the cylindrical section.

17. The method according to claim 11, wherein when the cylindrical wall is caused to rotate in a rotating direction, each of the windows comprises a leading side and a trailing side, and wherein each of the angle-cutting edges is located on the trailing side of the window.

18. The method according to claim 12, wherein when the cylindrical wall is caused to rotate in a rotating direction, each of said one or more openings comprises a leading side and a trailing side, and wherein each of the front-cutting edges is located on the trailing side of the opening.
